(19) United States
(12) Patent Application Publication
(10) Pub. No.: US 2026/0086729 A1
(43) Pub. Date: Mar. 26, 2026

(54) SYSTEMS, METHODS, AND MEDIA FOR PERFORMING COPYBACK OPERATIONS

(71) Applicant: SK hynix NAND Product Solutions Corp., Rancho Cordova, CA (US)

(72) Inventors: Yihua Zhang, Folsom, CA (US); Orapin Yoder, Chandler, AZ (US); Shankar Natarajan, Folsom, CA (US); Ehsan Esmaili, Rancho Cordova, CA (US)

(21) Appl. No.: 18/891,911

(22) Filed: Sep. 20, 2024

(51) Int. Cl. G06F 3/06

(52) U.S. Cl. CPC G06F 3/0647; G06F 3/0604; G06F 3/0656; G06F 3/0679

(57) ABSTRACT

Mechanisms, including systems, methods, and media, for performing a copyback operation are provided, the methods including: receiving first data being copied from a first source page to a first destination page of a physical media device from the physical media device; generating first error corrected data to correct errors in the first data; determining a first number of errors in the first data using a hardware processor; determining that the first number of errors does not meet a threshold; and in response to determining that the first number of errors in the first data does not meet the threshold, sending second data that includes the first error corrected data to the physical media device, wherein an amount of second data sent is less than an amount of the first data received.

### BACKGROUND

An internal copyback feature of some storage devices improves sustained sequential write performance and typically involves data migration by reading data from one or more source pages of physical media and writing that data to one or more destination pages of the physical media without the need to transfer the data externally through a controller, hence, saving data transfer time. However, copying data without passing it through a controller can come with a cost of data integrity risk as errors in the data from a source page can propagate to a destination page, and such errors can accumulate over multiple internal copyback operations, since there is no error correction being performed during the internal copyback (whereas copyback via a controller usually includes an error correction process).

Accordingly, new mechanisms for performing copyback operations are desirable.

### SUMMARY OF THE INVENTION

In accordance with embodiment some embodiments, mechanisms, including systems, methods and media, for performing copyback operations are provided.

In some embodiments, systems for performing a copyback operation are provided, the systems comprising: memory; and at least one hardware processor that is collectively configured to at least: receive first data being copied from a first source page to a first destination page of a physical media device from the physical media device; generate first error corrected data to correct errors in the first data; determine a first number of errors in the first data; determine that the first number of errors does not meet a threshold; and in response to determining that the first number of errors in the first data does not meet the threshold, send second data that includes the first error corrected data to the physical media device, wherein an amount of second data sent is less than an amount of the first data received. In some of these embodiments, the first number of errors in the first data does not meet the threshold when the first number or errors is less than or less than or equal to the threshold. In some of these embodiments, the systems further comprise the physical media device, and the physical media device is configured to at least: receive the second data; apply the first error corrected data to a buffer containing the first data; and write data in the buffer to the first destination page. In some of these embodiments, the at least one hardware processor is further collectively configured to at least: receive third data being copied from a third source page to a third destination page of the physical media device from the physical media device; generate third error corrected data to correct errors in the third data; determine a third number of errors in the third data; determine that the third number of errors meets a threshold; and in response to determining that the third number of errors in the third data meets the threshold, send fourth data that includes the second error corrected data and portions of the third data not containing errors to the physical media device. In some of these embodiments, the third number of errors in the third data meets the threshold when the third number or errors is equal to or greater than or equal to the threshold. In some of these embodiments, the systems further comprise the physical media device, and the physical media device is configured to at least: receive the fourth data; overwrite a buffer containing the third data with the fourth data; and write data in the buffer to the third destination page.

In some of these embodiments, methods for performing a copyback operation are provided, the methods comprising: receiving first data being copied from a first source page to a first destination page of a physical media device from the physical media device; generating first error corrected data to correct errors in the first data; determining a first number of errors in the first data using a hardware processor; determining that the first number of errors does not meet a threshold; and in response to determining that the first number of errors in the first data does not meet the threshold, sending second data that includes the first error corrected data to the physical media device, wherein an amount of second data sent is less than an amount of the first data received. In some of these embodiments, the first number of errors in the first data does not meet the threshold when the first number or errors is less than or less than or equal to the threshold. In some of these embodiments, the methods further comprise: receiving the second data at the physical media device; applying the first error corrected data to a buffer containing the first data; and writing data in the buffer to the first destination page. In some of these embodiments, the methods further comprise: receiving third data being copied from a third source page to a third destination page of the physical media device from the physical media device; generating third error corrected data to correct errors in the third data; determining a third number of errors in the third data; determining that the third number of errors meets a threshold; and in response to determining that the third number of errors in the third data meets the threshold, sending fourth data that includes the second error corrected data and portions of the third data not containing errors to the physical media device. In some of these embodiments, the third number of errors in the third data meets the threshold when the third number or errors is equal to or greater than or equal to the threshold. In some of these embodiments, the methods further comprise: receiving the fourth data at the physical media device; overwriting a buffer containing the third data with the fourth data; and writing data in the buffer to the third destination page.

In some embodiments, non-transitory computer-readable medium containing computer executable instructions that, when executed by a processor, cause the processor to perform a method for performing a copyback operation are provided, the method comprising: receiving first data being copied from a first source page to a first destination page of a physical media device from the physical media device; generating first error corrected data to correct errors in the first data; determining a first number of errors in the first data; determining that the first number of errors does not meet a threshold; and in response to determining that the first number of errors in the first data does not meet the threshold, sending second data that includes the first error corrected data to the physical media device, wherein an amount of second data sent is less than an amount of the first data received. In some of these embodiments, the first number of errors in the first data does not meet the threshold when the first number or errors is less than or less than or equal to the threshold. In some of these embodiments, the method further comprises: receiving the second data at the physical media device; applying the first error corrected data to a buffer containing the first data; and writing data in the buffer to the first destination page. In some of these embodiments, the method further comprises: receiving third data being copied from a third source page to a third destination page of the physical media device from the physical media device; generating third error corrected data to correct errors in the third data; determining a third number of errors in the third data; determining that the third number of errors meets a threshold; and in response to determining that the third number of errors in the third data meets the threshold, sending fourth data that includes the second error corrected data and portions of the third data not containing errors to the physical media device. In some of these embodiments, the third number of errors in the third data meets the threshold when the third number or errors is equal to or greater than or equal to the threshold. In some of these embodiments, the method further comprises: receiving the fourth data at the physical media device; overwriting a buffer containing the third data with the fourth data; and writing data in the buffer to the third destination page.

### BRIEF DESCRIPTION OF THE DRAWINGS

FIG. 1 is a block diagram of example hardware that can be used in accordance with some embodiments.

FIG. 2 shows an example flow diagram of a process for implementing copyback operations in accordance with some embodiments.

### DETAILED DESCRIPTION

In accordance with some embodiments, mechanisms, including systems, methods and media, for performing copyback operations are provided.

In some embodiments, mechanisms described herein perform error checking and error correction in a controller on data being copied from a source page to a destination page of physical media, and, based on the number of errors that are found, either transfer only corrected pieces of data or all data with error corrections from the controller to the physical, which can then use the transferred data to write to the destination page.

Some embodiments can be implemented in solid-state drives (SSDs), though the mechanisms described herein are not limited to being implemented in SSDs.

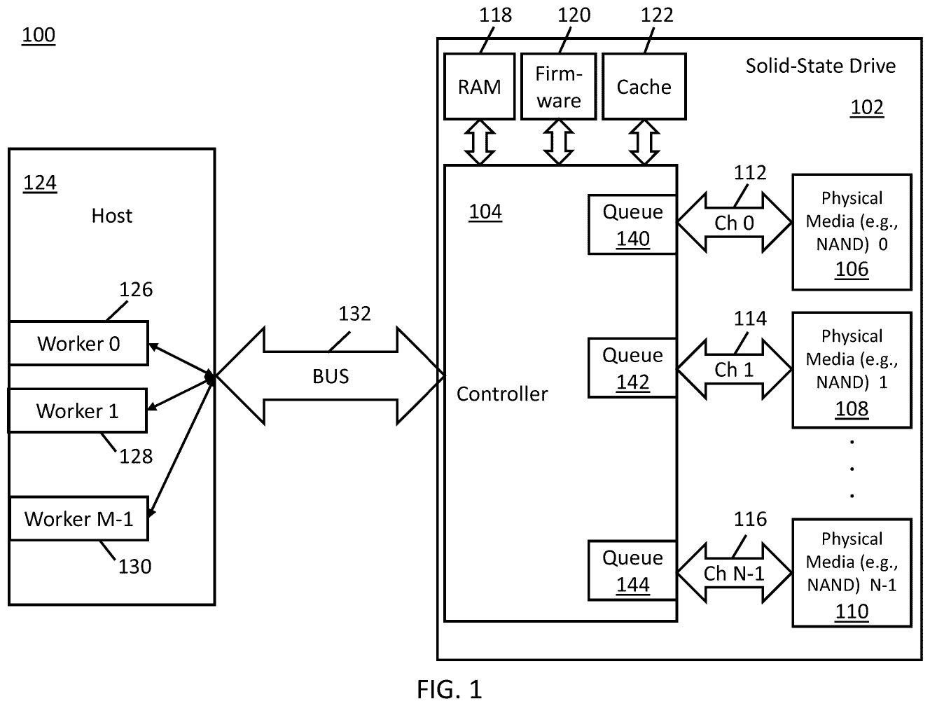

Turning to FIG. 1, an example block diagram of a solid-state drive 102 coupled to a host device 124 via a bus 132 in accordance with some embodiments is illustrated.

As shown, solid-state drive 102 can include a controller 104, physical media (e.g., non-volatile memory (NVM) (e.g., NAND devices)) 106, 108, and 110, channels 112, 114, and 116, random access memory (RAM) 118, firmware 120, and cache 122, in some embodiments. In some embodiments, more or fewer components than shown in FIG. 1 can be included. In some embodiments, two or more components shown in FIG. 1 can be included in one component.

Controller 104 can be any suitable controller for a solid-state drive in some embodiments. In some embodiments, controller 104 can include any suitable hardware processor(s) (such as a microprocessor, a digital signal processor, a microcontroller, a programmable gate array, etc.). In some embodiments, controller 104 can also include any suitable memory (such as RAM, firmware, cache, buffers, latches, etc.), interface controller(s), interface logic, drivers, etc. In some embodiments, controller 104 can be coupled to, or include (as shown), channel queues 140, 142, and 144 for transmitting commands (which can include command data) over channels 140, 142, and 144 to physical media 106, 108, and 110, respectively.

Physical media 106, 108, and 110 can be any suitable physical media for storing information (which can include data, programs, and/or any other suitable information that can be stored in a solid-state drive) in some embodiments. For example, the physical media can be NVM devices or NAND devices in some embodiments.

The physical media can include any suitable memory cells, hardware processor(s) (such as a microprocessor, a digital signal processor, a microcontroller, a programmable gate array, etc.), interface controller(s), interface logic, drivers, etc. in some embodiments. While three physical media (106, 108, and 110) are shown in FIG. 1, any suitable number D of physical media (including only one) can be used in some embodiments. Any suitable type of physical media (such as single-level cell (SLC) NAND devices, multilevel cell (MLC) NAND devices, triple-level cell (TLC) NAND devices, quad-level cell (QLC) NAND devices, penta-level cell (PLC) NAND, NAND with suitable levels of cells, 2D NAND devices, 3D NAND devices, NOR flash memory, any other suitable flash technology, phase change memory technology, and/or other any other suitable volatile and/or non-volatile memory storage technology) can be used in some embodiments. Each physical media can have any suitable size in some embodiments. While physical media 106, 108, and 110 can be implemented using NAND devices, the devices can additionally or alternatively use any other suitable storage technology or technologies, such as NOR flash memory or any other suitable flash technology, phase change memory technology, and/or other any other suitable non-volatile memory storage technology.

Channels 112, 114, and 116 can be any suitable mechanism for communicating information between controller 104 and physical media 106, 108, and 110 in some embodiments. For example, the channels can be implemented using conductors (lands) on a circuit board in some embodiments. While three channels (112, 114, and 116) are shown in FIG. 1, any suitable number C of channels can be used in some embodiments.

Random access memory (RAM) 118 can include any suitable type of RAM, such as dynamic RAM, static RAM, etc., in some embodiments. Any suitable number of RAM 118 can be included, and each RAM 118 can have any suitable size, in some embodiments.

Firmware 120 can include any suitable combination of software and hardware in some embodiments. For example, firmware 120 can include software programmed in any suitable programmable read only memory (PROM) in some embodiments. Any suitable number of firmware 120, each having any suitable size, can be used in some embodiments.

Cache 122 can be any suitable device for temporarily storing information (which can include data and programs in some embodiments), in some embodiments. Cache 122 can be implemented using any suitable type of device, such as RAM (e.g., static RAM, dynamic RAM, etc.) in some embodiments. Any suitable number of cache 122, each having any suitable size, can be used in some embodiments.

Host device 124 can be any suitable device that accesses stored information in some embodiments. For example, in some embodiment, host device 124 can be a general-purpose computer, a special-purpose computer, a desktop computer, a laptop computer, a tablet computer, a server, a database, a router, a gateway, a switch, a mobile phone, a communication device, an entertainment system (e.g., an automobile entertainment system, a television, a set-top box, a music player, etc.), a navigation system, etc. While only one host device 124 is shown in FIG. 1, any suitable number of host devices can be included in some embodiments.

In some embodiments, host device 124 can include workers 126, 128, and 130. While three workers (126, 128, and 130) are shown in FIG. 1, any suitable number of workers W can be included in some embodiments. In some embodiments, at least two workers can be included. A worker can be any suitable hardware and/or software that reads and/or writes data from and/or to solid-state drive 102.

Bus 132 can be any suitable bus for communicating information (which can include data and/or programs in some embodiments), in some embodiments. For example, in some embodiments, bus 132 can be a PCIE bus, a SATA bus, or any other suitable bus.

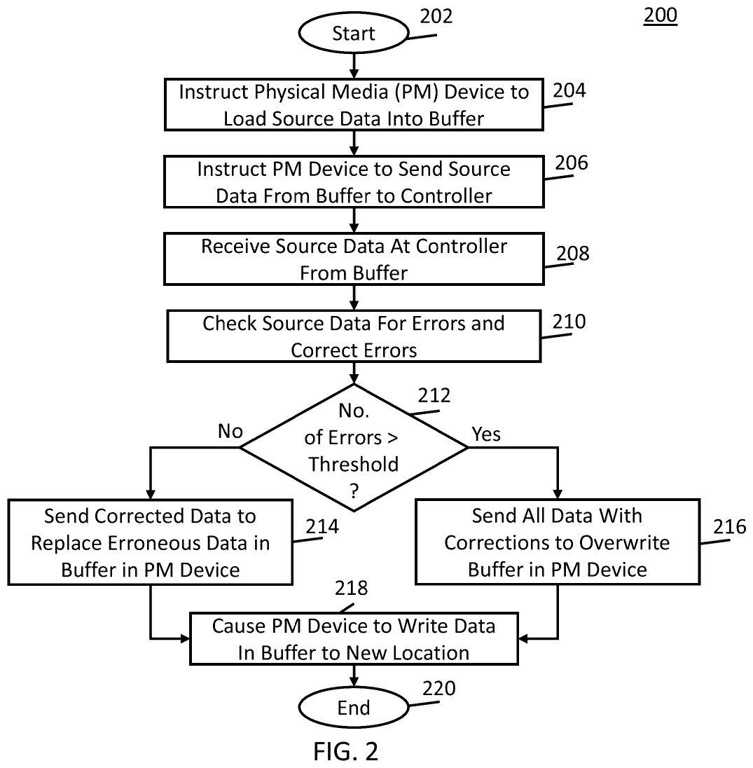

Turning to FIG. 2, an example process 200 in accordance with some embodiments is shown. Process 200 can be executed by a controller of a storage device (e.g., controller 104), in some embodiments. While FIG. 2 can be implemented in the context of a NAND physical media device, it should be understood that embodiments described herein are not limited to implementation in NAND devices.

As shown in FIG. 2, after process 200 begins at 202, the process instructs a physical media (PM) device (such as a NAND device), such as PM device 106, 108, or 110, to load source data into a buffer of the PM device at 204. This instruction can be made in any suitable manner, in some embodiments. For example, in some embodiments, this instruction can be made by sending a suitable command to the PM device via a corresponding channel 112, 114, or 116.

In response to this command, the PM device can load the source data into a buffer of the PM device. This data can be loaded into any suitable buffer of the PM device in suitable manner, in some embodiments.

Then, at 206, process 200 instructs the PM device to send the source data from the buffer to the controller. This instruction can be made in any suitable manner, in some embodiments. For example, in some embodiments, this instruction can be made by sending a suitable command to the PM device via a corresponding channel 112, 114, or 116.

Next, at 208, process 200 can receive the source data at the controller from the buffer of the PM device. This data can be received in any suitable manner, in some embodiments. For example, in some embodiments, this data can be received from the buffer via a corresponding channel 112, 114, or 116.

At 210, process 200 can check the source data for errors, correct the errors, and determine an amount of errors detected. Checking the source data for errors can be performed in any suitable manner using any suitable mechanism, in some embodiments. For example, in some embodiments, the source data can be checked for errors using a low-density parity-check mechanism (which can include any suitable combination of hardware and/or software, in some embodiments) and any detected errors corrected.

Then, at 212, process 200 can determine if the number of errors detected at 210 meets a threshold. This determination can be made in any suitable manner, in some embodiments. For example, process 200 can determine that the number of errors meets the threshold if the number of errors is greater than the threshold, in some embodiments. As another example, process 200 can determine that the number of errors meets the threshold if the number of errors is greater than or equal to the threshold, in some embodiments.

If it is determined at 212 that the number of errors does not meet the threshold, then process 200 can branch to 214 at which it can send corrected data to the PM device to replace the erroneous data in the buffer. Process 200 can send the corrected data to the PM device in any suitable manner in some embodiments. For example, in some embodiments, process 200 can send the corrected data to the PM device via a corresponding channel 112, 114, or 116.

In some embodiments, the data sent at 214 only includes data needed to correct errors detected at 210. In some embodiments, the data sent at 214 includes data need to correct errors detected at 210 as well as other data, but an amount of data that is less than the amount of data in the buffer.

If it is determined at 212 that the number of errors does meet the threshold, then process 200 can branch to 216 at which it can send all data with error corrections to overwrite the buffer in the PM device. That is, if X bytes of data was received at 208, then X bytes of data can be sent at 216 where the data sent is the data received at 206 but any erroneous data received at 206 corrected. Process 200 can send all data with error corrections to the PM device in any suitable manner in some embodiments. For example, in some embodiments, process 200 can send all data with error corrections to the PM device via a corresponding channel 112, 114, or 116.

After performing 214 or 216, process 200 can write the data in the buffer to a new (destination) location and then end at 218. Writing the data at 220 can be performed in any suitable manner, in some embodiments.

In some embodiments, at least some of the above-described blocks of the process of FIG. 2 can be executed or performed in any order or sequence not limited to the order and sequence shown in and described in connection with the figure. Also, some of the above blocks of the process of FIG. 2 can be executed or performed substantially simultaneously where appropriate or in parallel to reduce latency and processing times in some embodiments. Additionally or alternatively, some of the above described blocks of the process of FIG. 2 can be omitted in some embodiments.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

As can be seen from the description above, new mechanisms (which can include systems, methods, and media) for performing copyback operations are provided. These mechanisms improve the performance of storage devices (e.g., SSDs) by checking data being copied from a source page to a destination page for errors in a controller and only transmitting all of the data being copied from the controller to a physical media device (e.g., an NVM device, NAND device, etc.) when the number of errors meets a threshold, and just send corrected pieces of data otherwise. This will decrease the amount of data being transferred from the controller to the physical media devices during copyback operations.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for performing a copyback operation, comprising:
memory; and
at least one hardware processor that is collectively configured to at least:
receive first data being copied from a first source page to a first destination page of a physical media device from the physical media device;
generate first error corrected data to correct errors in the first data;
determine a first number of errors in the first data;
determine that the first number of errors does not meet a threshold; and
in response to determining that the first number of errors in the first data does not meet the threshold, send second data that includes the first error corrected data to the physical media device, wherein an amount of second data sent is less than an amount of the first data received.

2. The system of claim 1, wherein the first number of errors in the first data does not meet the threshold when the first number or errors is less than or less than or equal to the threshold.

3. The system of claim 1, further comprising the physical media device, wherein the physical media device is configured to at least:
receive the second data;
apply the first error corrected data to a buffer containing the first data; and
write data in the buffer to the first destination page.

4. The system of claim 1, wherein the at least one hardware processor is further collectively configured to at least:
receive third data being copied from a third source page to a third destination page of the physical media device from the physical media device;
generate third error corrected data to correct errors in the third data;
determine a third number of errors in the third data;
determine that the third number of errors meets a threshold; and
in response to determining that the third number of errors in the third data meets the threshold, send fourth data that includes the second error corrected data and portions of the third data not containing errors to the physical media device.

5. The system of claim 4, wherein the third number of errors in the third data meets the threshold when the third number or errors is equal to or greater than or equal to the threshold.

6. The system of claim 4, further comprising the physical media device, wherein the physical media device is configured to at least:
receive the fourth data;
overwrite a buffer containing the third data with the fourth data; and
write data in the buffer to the third destination page.

7. A method for performing a copyback operation, comprising:
receiving first data being copied from a first source page to a first destination page of a physical media device from the physical media device;
generating first error corrected data to correct errors in the first data;
determining a first number of errors in the first data using a hardware processor;
determining that the first number of errors does not meet a threshold; and
in response to determining that the first number of errors in the first data does not meet the threshold, sending second data that includes the first error corrected data to the physical media device, wherein an amount of second data sent is less than an amount of the first data received.

8. The method of claim 7, wherein the first number of errors in the first data does not meet the threshold when the first number or errors is less than or less than or equal to the threshold.

9. The method of claim 7, further comprising:
receiving the second data at the physical media device;
applying the first error corrected data to a buffer containing the first data; and
writing data in the buffer to the first destination page.

10. The method of claim 7, further comprising:
receiving third data being copied from a third source page to a third destination page of the physical media device from the physical media device;
generating third error corrected data to correct errors in the third data;
determining a third number of errors in the third data;
determining that the third number of errors meets a threshold; and
in response to determining that the third number of errors in the third data meets the threshold, sending fourth data that includes the second error corrected data and portions of the third data not containing errors to the physical media device.

11. The method of claim 10, wherein the third number of errors in the third data meets the threshold when the third number or errors is equal to or greater than or equal to the threshold.

12. The method of claim 10, further comprising:
receiving the fourth data at the physical media device;
overwriting a buffer containing the third data with the fourth data; and
writing data in the buffer to the third destination page.

13. A non-transitory computer-readable medium containing computer executable instructions that, when executed by a processor, cause the processor to perform a method for performing a copyback operation, the method comprising:
receiving first data being copied from a first source page to a first destination page of a physical media device from the physical media device;
generating first error corrected data to correct errors in the first data;
determining a first number of errors in the first data;
determining that the first number of errors does not meet a threshold; and
in response to determining that the first number of errors in the first data does not meet the threshold, sending second data that includes the first error corrected data to the physical media device, wherein an amount of second data sent is less than an amount of the first data received.

14. The non-transitory computer-readable medium of claim 13, wherein the first number of errors in the first data does not meet the threshold when the first number or errors is less than or less than or equal to the threshold.

15. The non-transitory computer-readable medium of claim 13, wherein the method further comprises:
receiving the second data at the physical media device;
applying the first error corrected data to a buffer containing the first data; and
writing data in the buffer to the first destination page.

16. The non-transitory computer-readable medium of claim 13, wherein the method further comprises:
receiving third data being copied from a third source page to a third destination page of the physical media device from the physical media device;
generating third error corrected data to correct errors in the third data;
determining a third number of errors in the third data;
determining that the third number of errors meets a threshold; and
in response to determining that the third number of errors in the third data meets the threshold, sending fourth data that includes the second error corrected data and portions of the third data not containing errors to the physical media device.

17. The non-transitory computer-readable medium of claim 16, wherein the third number of errors in the third data meets the threshold when the third number or errors is equal to or greater than or equal to the threshold.

18. The non-transitory computer-readable medium of claim 16, wherein the method further comprises:
receiving the fourth data at the physical media device;
overwriting a buffer containing the third data with the fourth data; and
writing data in the buffer to the third destination page.
